(19) United States
(12) Patent Application Publication
(10) Pub. No.: US 2021/0065038 A1
(43) Pub. Date: Mar. 4, 2021

(54) Method, System, and Computer Program Product for Maintaining Model State

(71) Applicant: Visa International Service Association, San Francisco, CA (US)

(72) Inventors: Yu Gu, Austin, TX (US); Ajay Raman Rayapati, Georgetown, TX (US); Chinh Do, Round Rock, TX (US); Ranglin Lu, Austin, TX (US); Subir Roy, Austin, TX (US); Yinhe Cheng, Austin, TX (US)

(21) Appl. No.: 16/550,520

(22) Filed: Aug. 26, 2019

(51) Int. Cl. G06N 20/00; G06F 7/24

(52) U.S. Cl. CPC G06N 20/00; G06F 7/24

(57) ABSTRACT

A method, system, and computer program product for maintaining model state at model data centers hosting a same machine learning model may receive first input data input, at a first time, to a first implementation of a model to generate first output data, the first implementation of the model being associated with a first model state at a time before the first time; receive second input data input, at a second time different than the first time, to a second implementation of the model to generate second output data, the second implementation of the model being associated with a second model state at a time before the second time; determine, based on the first input data and the second input data, update data for the first model state of the first implementation and the second model state of the second implementation; and provide, at a third time subsequent to the first time and the second time, the update data.

### BACKGROUND

### 1. Field

This disclosure relates generally to systems, devices, products, apparatus, and methods for maintaining model state, and in some embodiments or aspects, to a method, a system, and a product for maintaining in order model state progression across data centers for stateful machine learning models.

### 2. Technical Considerations

Similar to human memory, stateful machine learning models may take sequential time-series input and selectively transform and maintain certain input information as part of model state. For example, when a stateful model receives an input, the stateful model may generate an output and update the model state based on the input. Examples of stateful machine learning models include neural networks that use long-short-term-memory (LSTM), gated recurrent units (GRU), and/or the like.

Many applications that receive sequential time-based events (e.g., fraud detection applications, stand-in processing applications, advertising applications, marketing applications, etc.) use stateful machine learning models to improve performance of the applications as compared to applications that use stateless machine learning models. However, for multi-data center operations, network latency between the data centers may affect in-order model state updates with respect to sequential time-based events or inputs, which may cause stateful models for these applications to execute incorrectly and/or reduce the accuracy thereof. Accordingly, there is a need in the art for improving maintenance of model states.

### SUMMARY

Accordingly, provided are improved systems, devices, products, apparatus, and/or methods for maintaining model state.

According to some non-limiting embodiments or aspects, provided is a computer-implemented method including: receiving, with at least one processor, first input data input, at a first time, to a first implementation of a machine learning model to generate first output data, the first implementation of the machine learning model being associated with a first model state at a time before the first time; receiving, with at least one processor, second input data input, at a second time different than the first time, to a second implementation of the machine learning model to generate second output data, the second implementation of the machine learning model being associated with a second model state at a time before the second time; determining, with at least one processor, based on the first input data and the second input data, update data for the first model state of the first implementation of the machine learning model and the second model state of the second implementation of the machine learning model; and providing, with at least one processor, at a third time subsequent to the first time and the second time, the update data for the first model state of the first implementation of the machine learning model and the second model state of the second implementation of the machine learning model.

In some non-limiting embodiments or aspects, determining the update data includes sorting the first input data and the second input data based on the first time and the second time to generate sorted data, the update data being determined based on the sorted data.

In some non-limiting embodiments or aspects, determining the update data further includes determining, based on the sorted data, an updated model state for the first model state of the first implementation of the machine learning model and the second model state of the second implementation of the machine learning model, and providing the update data further includes providing the updated model state for the first model state of the first implementation of the machine learning model and the second model state of the second implementation of the machine learning model.

In some non-limiting embodiments or aspects, providing the update data further includes: providing the sorted data for the first model state of the first implementation of the machine learning model and the second model state of the second implementation of the machine learning model, and providing the update data further includes: determining, based on the sorted data, a first updated model state for the first model state of the first implementation of the machine learning model; updating the first model state of the first implementation of the machine learning model based on the first updated model state; determining a second updated model state for the second model state of the second implementation of the machine learning model; and updating the second model state of the second implementation of the machine learning model based on the second updated model state.

In some non-limiting embodiments or aspects, the method further includes: processing, at the first time, with at least one processor using the first implementation of the machine learning model, the first input data to generate the first output data without updating the first model state associated with the first implementation of the machine learning model.

In some non-limiting embodiments or aspects, the method further includes: processing, at the second time, with at least one processor using the second implementation of the machine learning model, the second input data to generate the second output data without updating the second model state associated with the second implementation of the machine learning model.

In some non-limiting embodiments or aspects, the first input data includes first transaction data associated with a first transaction initiated at the first time, and the second input data includes second transaction data associated with a second transaction initiated at the second time.

According to some non-limiting embodiments or aspects, provided is a computing system including: one or more processors programmed and/or configured to: receive first input data input, at a first time, to a first implementation of a machine learning model to generate first output data, the first implementation of the machine learning model being associated with a first model state at a time before the first time; receive second input data input, at a second time different than the first time, to a second implementation of the machine learning model to generate second output data, the second implementation of the machine learning model being associated with a second model state at a time before the second time; determine, based on the first input data and the second input data, update data for the first model state of the first implementation of the machine learning model and the second model state of the second implementation of the machine learning model; and provide at a third time subsequent to the first time and the second time, the update data for the first model state of the first implementation of the machine learning model and the second model state of the second implementation of the machine learning model.

In some non-limiting embodiments or aspects, the one or more processors determine the update data by sorting the first input data and the second input data based on the first time and the second time to generate sorted data, the update data being determined based on the sorted data.

In some non-limiting embodiments or aspects, the one or more processors determine the update data by determining, based on the sorted data, an updated model state for the first model state of the first implementation of the machine learning model and the second model state of the second implementation of the machine learning model, and the one or more processors provide the update data by providing the updated model state for the first model state of the first implementation of the machine learning model and the second model state of the second implementation of the machine learning model.

In some non-limiting embodiments or aspects, the system further includes: a first data center programmed and/or configured to provide the first implementation of the machine learning model; and a second data center programmed and/or configured to provide the second implementation of the machine learning model, the one or more processors provide the update data by providing, to the first data center and the second data center, the sorted data, the first data center is further programmed and/or configured to: determine, based on the sorted data, a first updated model state for the first model state of the first implementation of the machine learning model; and update the first model state of the first implementation of the machine learning model based on the first updated model state, and the second data center is further programmed and/or configured to: determine, based on the sorted data, a second updated model state for the second model state of the second implementation of the machine learning model; and update the second model state of the second implementation of the machine learning model based on the second updated model state.

In some non-limiting embodiments or aspects, the system further includes: a first data center programmed and/or configured to: provide the first implementation of the machine learning model; and process, at the first time, using the first implementation of the machine learning model, the first input data to generate the first output data without updating the first model state associated with the first implementation of the machine learning model.

In some non-limiting embodiments or aspects, the system further includes: a second data center programmed and/or configured to: provide the second implementation of the machine learning model; and process, at the second time, using the second implementation of the machine learning model, the second input data to generate the second output data without updating the second model state associated with the second implementation of the machine learning model.

In some non-limiting embodiments or aspects, the first input data includes first transaction data associated with a first transaction initiated at the first time, and the second input data includes second transaction data associated with a second transaction initiated at the second time.

According to some non-limiting embodiments or aspects, provided is a computer program product including at least one non-transitory computer-readable medium including program instructions that, when executed by at least one processor, cause the at least one processor to: receive first input data input, at a first time, to a first implementation of a machine learning model to generate first output data, the first implementation of the machine learning model being associated with a first model state at a time before the first time; receive second input data input, at a second time different than the first time, to a second implementation of the machine learning model to generate second output data, the second implementation of the machine learning model being associated with a second model state at a time before the second time; determine based on the first input data and the second input data, update data for the first model state of the first implementation of the machine learning model and the second model state of the second implementation of the machine learning model; and provide at a third time subsequent to the first time and the second time, the update data for the first model state of the first implementation of the machine learning model and the second model state of the second implementation of the machine learning model.

In some non-limiting embodiments or aspects, the instructions cause the at least one processor to: determine the update data by sorting the first input data and the second input data based on the first time and the second time to generate sorted data, the update data being determined based on the sorted data.

In some non-limiting embodiments or aspects, the instructions cause the at least one processor to determine the update data by determining, based on the sorted data, an updated model state for the first model state of the first implementation of the machine learning model and the second model state of the second implementation of the machine learning model, and the instructions cause the at least one processor to provide the update data by providing the updated model state for the first model state of the first implementation of the machine learning model and the second model state of the second implementation of the machine learning model.

In some non-limiting embodiments or aspects, the instructions cause the at least one processor to provide the update data by: providing the sorted data as the update data for the first model state of the first implementation of the machine learning model and the second model state of the second implementation of the machine learning model; determining, based on the sorted data, a first updated model state for the first model state of the first implementation of the machine learning model; updating the first model state of the first implementation of the machine learning model based on the first updated model state; determining a second updated model state for the second model state of the second implementation of the machine learning model; and updating the second model state of the second implementation of the machine learning model based on the second updated model state.

In some non-limiting embodiments or aspects, the instructions further cause the at least one processor to: process, at the first time, using the first implementation of the machine learning model, the first input data to generate the first output data without updating the first model state associated with the first implementation of the machine learning model; and process, at the second time, using the second implementation of the machine learning model, the second input data to generate the second output data without updating the second model state associated with the second implementation of the machine learning model.

In some non-limiting embodiments or aspects, the first input data includes first transaction data associated with a first transaction initiated at the first time, and the second input data includes second transaction data associated with a second transaction initiated at the second time.

Further embodiments or aspects are set forth in the following numbered clauses:

Clause 1. A computer-implemented method comprising: receiving, with at least one processor, first input data input, at a first time, to a first implementation of a machine learning model to generate first output data, wherein the first implementation of the machine learning model is associated with a first model state at a time before the first time; receiving, with at least one processor, second input data input, at a second time different than the first time, to a second implementation of the machine learning model to generate second output data, wherein the second implementation of the machine learning model is associated with a second model state at a time before the second time; determining, with at least one processor, based on the first input data and the second input data, update data for the first model state of the first implementation of the machine learning model and the second model state of the second implementation of the machine learning model; and providing, with at least one processor, at a third time subsequent to the first time and the second time, the update data for the first model state of the first implementation of the machine learning model and the second model state of the second implementation of the machine learning model.

Clause 2. The computer-implemented method of clause 1, wherein determining the update data includes sorting the first input data and the second input data based on the first time and the second time to generate sorted data, and wherein the update data is determined based on the sorted data.

Clause 3. The computer-implemented method of clauses 1 or 2, wherein determining the update data further includes determining, based on the sorted data, an updated model state for the first model state of the first implementation of the machine learning model and the second model state of the second implementation of the machine learning model, and wherein providing the update data further includes providing the updated model state for the first model state of the first implementation of the machine learning model and the second model state of the second implementation of the machine learning model.

Clause 4. The computer-implemented method of any of clauses 1-3, wherein providing the update data further includes: providing the sorted data for the first model state of the first implementation of the machine learning model and the second model state of the second implementation of the machine learning model, and wherein providing the update data further includes: determining, based on the sorted data, a first updated model state for the first model state of the first implementation of the machine learning model; updating the first model state of the first implementation of the machine learning model based on the first updated model state; determining a second updated model state for the second model state of the second implementation of the machine learning model; and updating the second model state of the second implementation of the machine learning model based on the second updated model state.

Clause 5. The computer-implemented method of any of clauses 1-4, further comprising: processing, at the first time, with at least one processor using the first implementation of the machine learning model, the first input data to generate the first output data without updating the first model state associated with the first implementation of the machine learning model.

Clause 6. The computer-implemented method of any of clauses 1-5, further comprising: processing, at the second time, with at least one processor using the second implementation of the machine learning model, the second input data to generate the second output data without updating the second model state associated with the second implementation of the machine learning model.

Clause 7. The computer-implemented method of any of clauses 1-6, wherein the first input data includes first transaction data associated with a first transaction initiated at the first time, and wherein the second input data includes second transaction data associated with a second transaction initiated at the second time.

Clause 8. A computing system comprising: one or more processors programmed and/or configured to: receive first input data input, at a first time, to a first implementation of a machine learning model to generate first output data, wherein the first implementation of the machine learning model is associated with a first model state at a time before the first time; receive second input data input, at a second time different than the first time, to a second implementation of the machine learning model to generate second output data, wherein the second implementation of the machine learning model is associated with a second model state at a time before the second time; determine, based on the first input data and the second input data, update data for the first model state of the first implementation of the machine learning model and the second model state of the second implementation of the machine learning model; and provide at a third time subsequent to the first time and the second time, the update data for the first model state of the first implementation of the machine learning model and the second model state of the second implementation of the machine learning model.

Clause 9. The computing system of clause 8, wherein the one or more processors determine the update data by sorting the first input data and the second input data based on the first time and the second time to generate sorted data, wherein the update data is determined based on the sorted data.

Clause 10. The computing system of clauses 8 or 9, wherein the one or more processors determine the update data by determining, based on the sorted data, an updated model state for the first model state of the first implementation of the machine learning model and the second model state of the second implementation of the machine learning model, and wherein the one or more processors provide the update data by providing the updated model state for the first model state of the first implementation of the machine learning model and the second model state of the second implementation of the machine learning model.

Clause 11. The computing system of any of clauses 8-10, further comprising: a first data center programmed and/or configured to provide the first implementation of the machine learning model; a second data center programmed and/or configured to provide the second implementation of the machine learning model, wherein the one or more processors provide the update data by providing, to the first data center and the second data center, the sorted data, wherein the first data center is further programmed and/or configured to: determine, based on the sorted data, a first updated model state for the first model state of the first implementation of the machine learning model; and update the first model state of the first implementation of the machine learning model based on the first updated model state, and wherein the second data center is further programmed and/or configured to: determine, based on the sorted data, a second updated model state for the second model state of the second implementation of the machine learning model; and update the second model state of the second implementation of the machine learning model based on the second updated model state.

Clause 12. The computing system of any of clauses 8-11, further comprising: a first data center programmed and/or configured to: provide the first implementation of the machine learning model; and process, at the first time, using the first implementation of the machine learning model, the first input data to generate the first output data without updating the first model state associated with the first implementation of the machine learning model.

Clause 13. The computing system of any of clauses 8-12, further comprising: a second data center programmed and/or configured to: provide the second implementation of the machine learning model; and process, at the second time, using the second implementation of the machine learning model, the second input data to generate the second output data without updating the second model state associated with the second implementation of the machine learning model.

Clause 14. The computing system of any of clauses 8-13, wherein the first input data includes first transaction data associated with a first transaction initiated at the first time, and wherein the second input data includes second transaction data associated with a second transaction initiated at the second time.

Clause 15. A computer program product comprising at least one non-transitory computer-readable medium including program instructions that, when executed by at least one processor, cause the at least one processor to: receive first input data input, at a first time, to a first implementation of a machine learning model to generate first output data, wherein the first implementation of the machine learning model is associated with a first model state at a time before the first time; receive second input data input, at a second time different than the first time, to a second implementation of the machine learning model to generate second output data, wherein the second implementation of the machine learning model is associated with a second model state at a time before the second time; determine based on the first input data and the second input data, update data for the first model state of the first implementation of the machine learning model and the second model state of the second implementation of the machine learning model; and provide at a third time subsequent to the first time and the second time, the update data for the first model state of the first implementation of the machine learning model and the second model state of the second implementation of the machine learning model.

Clause 16. The computer program product of clause 15, wherein the instructions cause the at least one processor to determine the update data by sorting the first input data and the second input data based on the first time and the second time to generate sorted data, and wherein the update data is determined based on the sorted data.

Clause 17. The computer program product of clauses 15 or 16, wherein the instructions cause the at least one processor to determine the update data by determining, based on the sorted data, an updated model state for the first model state of the first implementation of the machine learning model and the second model state of the second implementation of the machine learning model, and wherein the instructions cause the at least one processor to provide the update data by providing the updated model state for the first model state of the first implementation of the machine learning model and the second model state of the second implementation of the machine learning model.

Clause 18. The computer program product of any of clauses 15-17, wherein the instructions cause the at least one processor to provide the update data by: providing the sorted data as the update data for the first model state of the first implementation of the machine learning model and the second model state of the second implementation of the machine learning model; determining, based on the sorted data, a first updated model state for the first model state of the first implementation of the machine learning model; updating the first model state of the first implementation of the machine learning model based on the first updated model state; determining a second updated model state for the second model state of the second implementation of the machine learning model; and updating the second model state of the second implementation of the machine learning model based on the second updated model state.

Clause 19. The computer program product of any of clauses 15-18, wherein the instructions further cause the at least one processor to: process, at the first time, using the first implementation of the machine learning model, the first input data to generate the first output data without updating the first model state associated with the first implementation of the machine learning model; and process, at the second time, using the second implementation of the machine learning model, the second input data to generate the second output data without updating the second model state associated with the second implementation of the machine learning model.

Clause 20. The computer program product of any of clauses 15-19, wherein the first input data includes first transaction data associated with a first transaction initiated at the first time, and wherein the second input data includes second transaction data associated with a second transaction initiated at the second time.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of limits. As used in the specification and the claims, the singular form of “a,” “an,” and “the” include plural referents unless the context clearly dictates otherwise.

### BRIEF DESCRIPTION OF THE DRAWINGS

Additional advantages and details are explained in greater detail below with reference to the exemplary embodiments or aspects that are illustrated in the accompanying schematic figures, in which:

FIG. 1A is a diagram of non-limiting embodiments or aspects of an environment in which systems, devices, products, apparatus, and/or methods, described herein, may be implemented;

FIG. 1B is a diagram of non-limiting embodiments or aspects of a system for maintaining model state;

FIG. 2 is a diagram of non-limiting embodiments or aspects of components of one or more devices and/or one or more systems of FIGS. 1A and 1B;

FIG. 3 is a flowchart of non-limiting embodiments or aspects of a process for maintaining model state; and

FIG. 4 is a signal flow diagram of an implementation of a non-limiting embodiment or aspect of a process for maintaining model state.

### DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

It will be apparent that systems and/or methods, described herein, can be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

As used herein, the term “transaction service provider” may refer to an entity that receives transaction authorization requests from merchants or other entities and provides guarantees of payment, in some cases through an agreement between the transaction service provider and an issuer institution. The terms “transaction service provider” and “transaction service provider system” may also refer to one or more computer systems operated by or on behalf of a transaction service provider, such as a transaction processing system executing one or more software applications. A transaction processing system may include one or more server computers with one or more processors and, in some non-limiting embodiments or aspects, may be operated by or on behalf of a transaction service provider.

As used herein, the term “account identifier” may include one or more Primary Account Numbers (PAN), tokens, or other identifiers (e.g., a globally unique identifier (GUID), a universally unique identifier (UUID), etc.) associated with a customer account of a user (e.g., a customer, a consumer, and/or the like). The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more databases such that they can be used to conduct a transaction without directly using the original account identifier. In some examples, an original account identifier, such as a PAN, may be associated with a plurality of tokens for different individuals or purposes.

As used herein, the terms “issuer institution,” “portable financial device issuer,” “issuer,” or “issuer bank” may refer to one or more entities that provide one or more accounts to a user (e.g., a customer, a consumer, an entity, an organization, and/or the like) for conducting transactions (e.g., payment transactions), such as initiating credit card payment transactions and/or debit card payment transactions. For example, an issuer institution may provide an account identifier, such as a personal account number (PAN), to a user that uniquely identifies one or more accounts associated with that user. The account identifier may be embodied on a portable financial device, such as a physical financial instrument (e.g., a payment card), and/or may be electronic and used for electronic payments. In some non-limiting embodiments or aspects, an issuer institution may be associated with a bank identification number (BIN) that uniquely identifies the issuer institution. As used herein “issuer institution system” may refer to one or more computer systems operated by or on behalf of an issuer institution, such as a server computer executing one or more software applications. For example, an issuer institution system may include one or more authorization servers for authorizing a payment transaction.

As used herein, the term “merchant” may refer to an individual or entity that provides products and/or services, or access to products and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices. The terms “client device” and “user device,” as used herein, refer to any electronic device that is configured to communicate with one or more servers or remote devices and/or systems. A client device or user device may include a mobile device, a network-enabled appliance (e.g., a network-enabled television, refrigerator, thermostat, and/or the like), a computer, a POS system, and/or any other device or system capable of communicating with a network.

As used herein, the term “computing device” or “computer device” may refer to one or more electronic devices that are configured to directly or indirectly communicate with or over one or more networks. The computing device may be a mobile device, a desktop computer, or the like. Furthermore, the term “computer” may refer to any computing device that includes the necessary components to receive, process, and output data, and normally includes a display, a processor, a memory, an input device, and a network interface. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.).

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Wallet™, Android Pay®, Apple Pay®, Samsung Pay®, and/or other like electronic payment systems. In some non-limiting examples, an issuer bank may be an electronic wallet provider.

As used herein, the term “portable financial device” or “payment device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a mobile device executing an electronic wallet application, a personal digital assistant (PDA), a security card, an access card, a wireless terminal, and/or a transponder, as examples. The portable financial device may include a volatile or a non-volatile memory to store information, such as an account identifier and/or a name of the account holder.

As used herein, the term “server” may refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, such as POS devices, directly or indirectly communicating in the network environment may constitute a “system,” such as a merchant's POS system.

As used herein, the term “acquirer” may refer to an entity licensed by the transaction service provider and/or approved by the transaction service provider to originate transactions using a portable financial device of the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As previously described herein, sequential time-based events or inputs, such as transactions, and/or the like, may be processed by multiple different data centers, but the model states of different implementations of the machine learning model for processing the transactions at the different data centers may not be updated in order with respect to the sequential time-based events (e.g., with respect to transaction times, etc.). For example, a first implementation of a machine learning model at a first data center may receive a first input at a first time T1 and use a model state at a time previous to the time T1 (e.g., previous to updating the model state based on the first input, etc.) to generate a first output and update the model state of the first implementation of the machine learning model at the first data center to a model state at time T1 based on the first input. A second implementation of the machine learning model at a second data center may receive a second input at a time T2 (e.g., after the time T1) and use a model state at a time previous to the time T2 (e.g., previous to updating the model state based on the second input, etc.) to generate a second output and update the model state of the second implementation of the machine learning model at the second data center to a model state at the time T2 based on the second input. The second implementation of the machine learning model at the second data center may receive a third input at a time T3 (e.g., after the time T2) and use a model state at a time previous to the time T3 (e.g., the model state at the time T2) to generate a third output and update the model state of the second implementation of the machine learning model at the second data center to a model state at the time T3 based on the third input. However, the second implementation of the second machine learning model at the second data center may subsequently receive the first input (e.g., which may be delayed due to network latency, etc.), which was previously received at the first data center at the time T1, at a time T4 (e.g., after the time T3) and use a model state at a time previous to the time T4 (e.g., the model state at the time T3) to generate a fourth output and update the model state of the second implementation of the machine learning model at the second data center to a model state at the time T4 based on the first input. Although the first input at the time T1 to the first data center may occur before the time T2 at the second data center, the second data center may receive the first input at the time T4 (e.g., after the actual event or input time at the first data center, after processing other events or inputs, such as transactions, and/or the like, received at the second data center during the delay in receipt of the first input at the second data center, etc.), and the second data center cannot recover the same model state as the first data center at time T1 used by the first data center to process the first input at time T1. For example, the second data center may use the model state at the time T3 (e.g., the latest model state at a time previous to the time T4) to process the first input and update the model state of the second implementation of the machine learning model at the second data center based on the first input.

In this way, the model state between the first implementation of the machine learning model at the first data center and the second implementation of the machine learning model at the second data center (and/or one or more further implementations of the machine learning model at one or more further data centers, etc.) may be inconsistent (e.g., due to different sequences of events being observed at different data centers, etc.). For example, network latency between the different data centers may lead to out of order events or inputs being received and processed at different data centers, thereby resulting in inconsistent model states between the data centers and/or inaccurate outputs therefrom.

Provided are improved systems, devices, products, apparatus, and/or methods for maintaining model state.

Non-limiting embodiments or aspects of the present disclosure are directed to systems, methods, and computer program products for maintaining model state that receive first input data input, at a first time, to a first implementation of a machine learning model to generate first output data, the first implementation of the machine learning model being associated with a first model state at a time before the first time; receive second input data input, at a second time different than the first time, to a second implementation of the machine learning model to generate second output data, the second implementation of the machine learning model being associated with a second model state at a time before the second time; determine, based on the first input data and the second input data, update data for the first model state of the first implementation of the machine learning model and the second model state of the second implementation of the machine learning model; and provide, at a third time subsequent to the first time and the second time, the update data for the first model state of the first implementation of the machine learning model and the second model state of the second implementation of the machine learning model.

In this way, non-limiting embodiments or aspects of the present disclosure may provide for separating model output generation and model state updates (e.g., by using input to a model and a latest available model state to generate model output without updating the model state when generating the model output, etc.) and for receiving inputs or events from different implementations or data centers for a machine learning model and sorting or reordering the inputs and providing the sorted or reordered inputs (e.g., in a sequential time-sorted or time-ordered batch, etc.) for updating the model states, which enables maintaining consistent model states between different implementations or data centers for the machine learning model. Accordingly, consistent model states between data centers and/or more accurate outputs therefrom may be maintained when out of order events or inputs are received and processed at different data centers due to network latency between the different data centers.

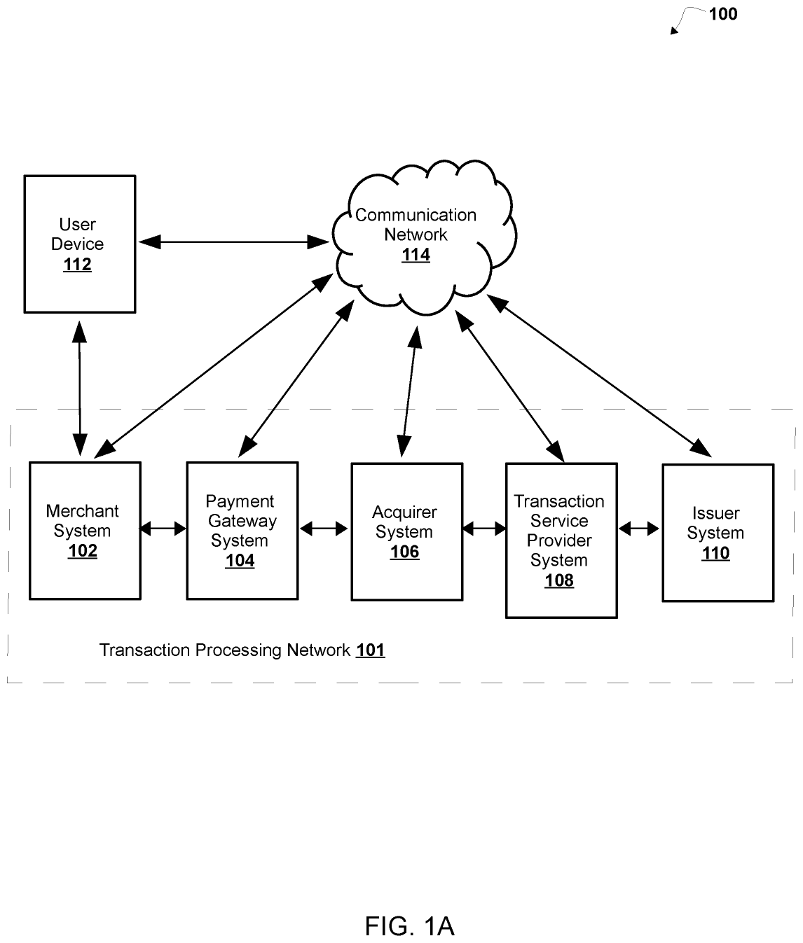

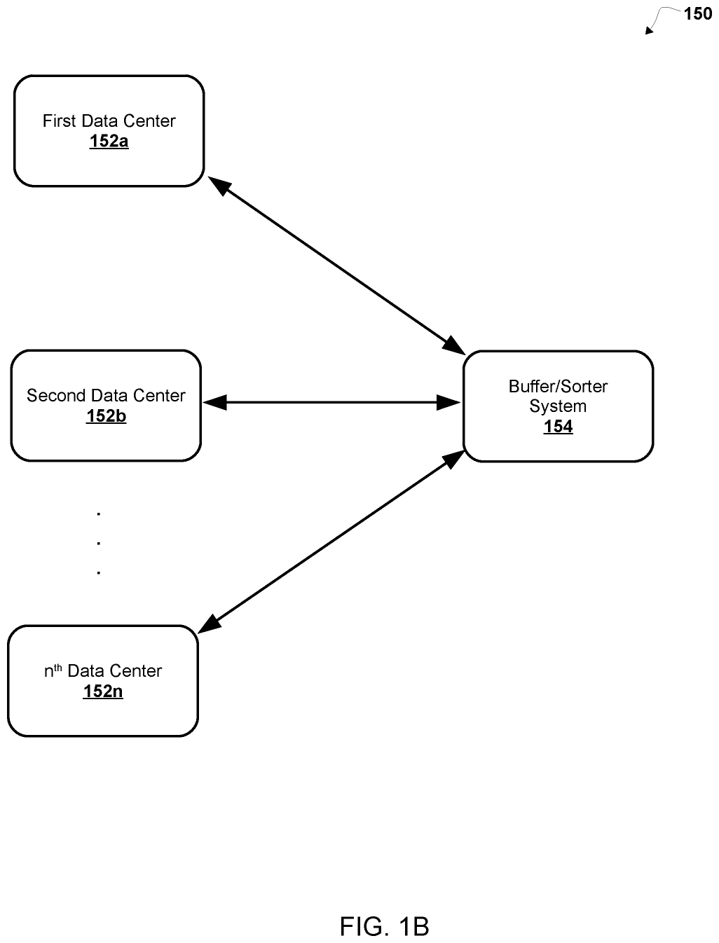

Referring now to FIG. 1A, FIG. 1A is a diagram of an example environment 100 in which devices, systems, methods, and/or products described herein, may be implemented. As shown in FIG. 1A, environment 100 includes transaction processing network 101, which may include merchant system 102, payment gateway system 104, acquirer system 106, transaction service provider system 108, and/or issuer system 110, user device 112, and/or communication network 114. Transaction processing network 101, merchant system 102, payment gateway system 104, acquirer system 106, transaction service provider system 108, issuer system 110, and/or user device 112 may interconnect (e.g., establish a connection to communicate, etc.) via wired connections, wireless connections, or a combination of wired and wireless connections.

Merchant system 102 may include one or more devices capable of receiving information and/or data from payment gateway system 104, acquirer system 106, transaction service provider system 108, issuer system 110, and/or user device 112 (e.g., via communication network 114, etc.) and/or communicating information and/or data to payment gateway system 104, acquirer system 106, transaction service provider system 108, issuer system 110, and/or user device 112 (e.g., via communication network 114, etc.). Merchant system 102 may include a device capable of receiving information and/or data from user device 112 via a communication connection (e.g., an NFC communication connection, an RFID communication connection, a Bluetooth® communication connection, etc.) with user device 112, and/or communicating information and/or data to user device 112 via the communication connection. For example, merchant system 102 may include a computing device, such as a server, a group of servers, a client device, a group of client devices, and/or other like devices. In some non-limiting embodiments or aspects, merchant system 102 may be associated with a merchant as described herein. In some non-limiting embodiments or aspects, merchant system 102 may include one or more devices, such as computers, computer systems, and/or peripheral devices capable of being used by a merchant to conduct a payment transaction with a user. For example, merchant system 102 may include a POS device and/or a POS system.

Payment gateway system 104 may include one or more devices capable of receiving information and/or data from merchant system 102, acquirer system 106, transaction service provider system 108, issuer system 110, and/or user device 112 (e.g., via communication network 114, etc.) and/or communicating information and/or data to merchant system 102, acquirer system 106, transaction service provider system 108, issuer system 110, and/or user device 112 (e.g., via communication network 114, etc.). For example, payment gateway system 104 may include a computing device, such as a server, a group of servers, and/or other like devices. In some non-limiting embodiments or aspects, payment gateway system 104 is associated with a payment gateway as described herein.

Acquirer system 106 may include one or more devices capable of receiving information and/or data from merchant system 102, payment gateway system 104, transaction service provider system 108, issuer system 110, and/or user device 112 (e.g., via communication network 114, etc.) and/or communicating information and/or data to merchant system 102, payment gateway system 104, transaction service provider system 108, issuer system 110, and/or user device 112 (e.g., via communication network 114, etc.). For example, acquirer system 106 may include a computing device, such as a server, a group of servers, and/or other like devices. In some non-limiting embodiments or aspects, acquirer system 106 may be associated with an acquirer as described herein.

Transaction service provider system 108 may include one or more devices capable of receiving information and/or data from merchant system 102, payment gateway system 104, acquirer system 106, issuer system 110, and/or user device 112 (e.g., via communication network 114, etc.) and/or communicating information and/or data to merchant system 102, payment gateway system 104, acquirer system 106, issuer system 110, and/or user device 112 (e.g., via communication network 114, etc.). For example, transaction service provider system 108 may include a computing device, such as a server (e.g., a transaction processing server, etc.), a group of servers, and/or other like devices. In some non-limiting embodiments or aspects, transaction service provider system 108 may be associated with a transaction service provider as described herein. In some non-limiting embodiments or aspects, transaction service provider 108 may include and/or access one or more one or more internal and/or external databases including account data, transaction data, merchant data, demographic data, and/or the like.

Issuer system 110 may include one or more devices capable of receiving information and/or data from merchant system 102, payment gateway system 104, acquirer system 106, transaction service provider system 108, and/or user device 112 (e.g., via communication network 114, etc.) and/or communicating information and/or data to merchant system 102, payment gateway system 104, acquirer system 106, transaction service provider system 108, and/or user device 112 (e.g., via communication network 114, etc.). For example, issuer system 110 may include a computing device, such as a server, a group of servers, and/or other like devices. In some non-limiting embodiments or aspects, issuer system 110 may be associated with an issuer institution as described herein. For example, issuer system 110 may be associated with an issuer institution that issued a payment account or instrument (e.g., a credit account, a debit account, a credit card, a debit card, etc.) to a user (e.g., a user associated with user device 112, etc.).

In some non-limiting embodiments or aspects, transaction processing network 101 includes a plurality of systems in a communication path for processing a transaction. For example, transaction processing network 101 may include merchant system 102, payment gateway system 104, acquirer system 106, transaction service provider system 108, and/or issuer system 110 in a communication path (e.g., a communication path, a communication channel, a communication network, etc.) for processing an electronic payment transaction. As an example, transaction processing network 101 may process (e.g., receive, initiate, conduct, authorize, etc.) an electronic payment transaction via the communication path between merchant system 102, payment gateway system 104, acquirer system 106, transaction service provider system 108, and/or issuer system 110.

User device 112 may include one or more devices capable of receiving information and/or data from merchant system 102, payment gateway system 104, acquirer system 106, transaction service provider system 108, and/or issuer system 110 (e.g., via communication network 114, etc.) and/or communicating information and/or data to merchant system 102, payment gateway system 104, acquirer system 106, transaction service provider system 108, and/or issuer system 110 (e.g., via communication network 114, etc.). For example, user device 112 may include a client device and/or the like. In some non-limiting embodiments or aspects, user device 112 may be capable of receiving information (e.g., from merchant system 102, etc.) via a short range wireless communication connection (e.g., an NFC communication connection, an RFID communication connection, a Bluetooth® communication connection, and/or the like), and/or communicating information (e.g., to merchant system 102, etc.) via a short range wireless communication connection. In some non-limiting embodiments or aspects, user device 112 may include an application associated with user device 112, such as an application stored on user device 112, a mobile application (e.g., a mobile device application, a native application for a mobile device, a mobile cloud application for a mobile device, an electronic wallet application, and/or the like) stored and/or executed on user device 112.

Communication network 114 may include one or more wired and/or wireless networks. For example, communication network 114 may include a cellular network (e.g., a long-term evolution (LTE) network, a third generation (3G) network, a fourth generation (4G) network, a fifth generation network (5F) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

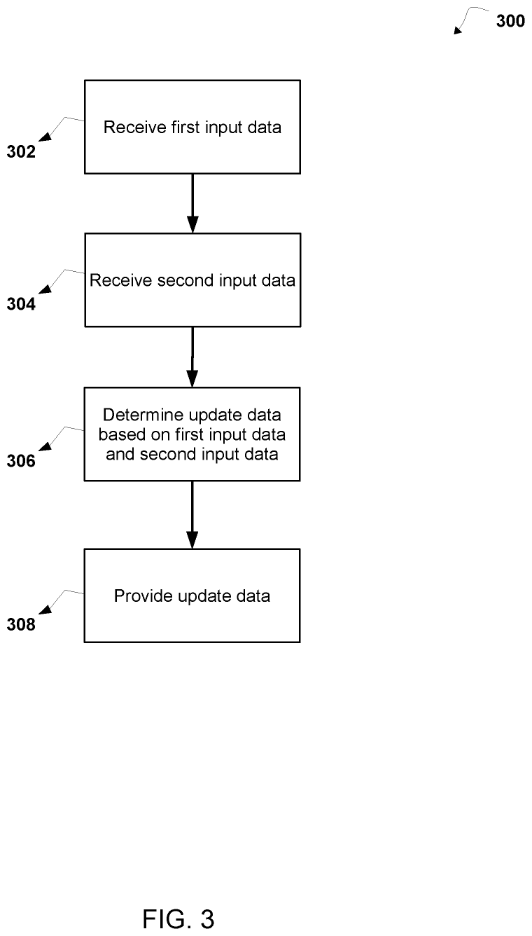

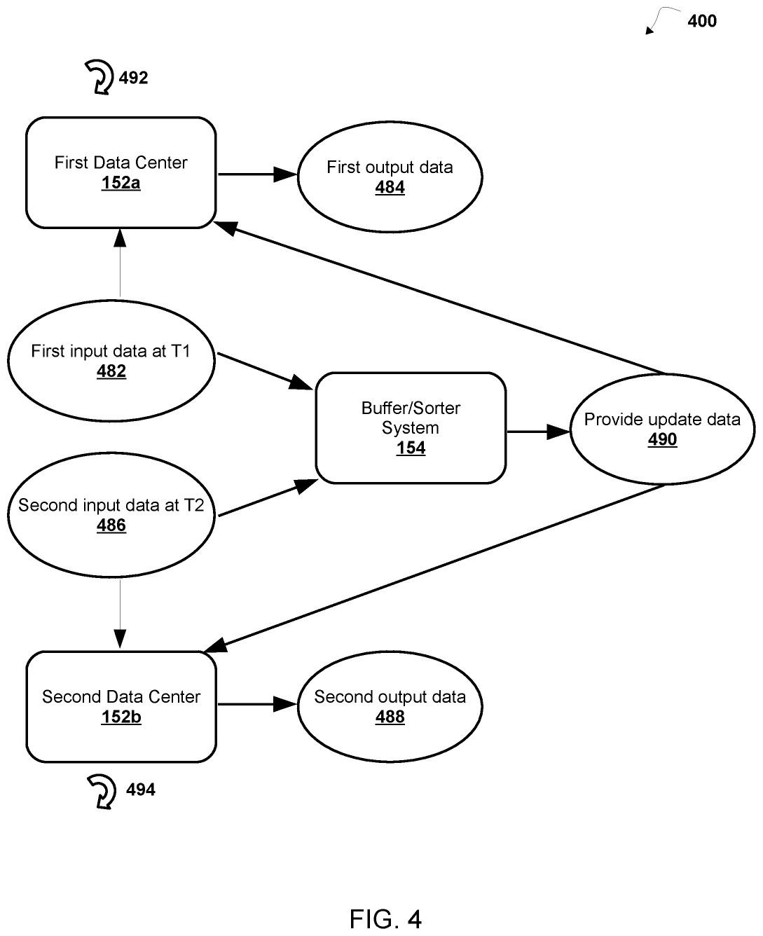

Referring now to FIG. 1B, FIG. 1B is a diagram of non-limiting embodiments or aspects of a system 150 for maintaining model state. System 150 may correspond to one or more devices of transaction processing network 101, one or more devices of merchant system 102, one or more devices of payment gateway system 104, one or more devices of acquirer system 106, one or more devices of transaction service provider system 108, one or more devices of issuer system 110, and/or user device 112 (e.g., one or more devices of a system of user device 112, etc.). As shown in FIG. 1B, system 150 includes a plurality of data centers, such as first data center 152a, second data center 152b, and/or n^{th} data center 152n, and/or buffer/sorter system 154. First data center 152a, second data center 152b, n^{th} data center 152n, and/or buffer/sorter system 154 may be implemented within a single device and/or system or distributed across multiple devices and/or systems (e.g., across multiple data centers and/or systems, etc.). System 150 may be programmed and/or configured to maintain in order model state progression across the data centers 152a, 152b, and/or 152n for stateful machine learning models and is described in more detail herein below with respect to FIGS. 3 and 4 which disclose processes therefor. For example, first data center 152a may be programmed and/or configured to provide a first implementation of a machine learning model, second data center 152b may be programmed and/or configured to provide a second implementation of the machine learning model, and/or n^{th} data center 152n may be programmed and/or configured to provide an n^{th} implementation of the machine learning model.

The number and arrangement of devices and systems shown in FIGS. 1A and 1B are provided as an example. There may be additional devices and/or systems, fewer devices and/or systems, different devices and/or systems, or differently arranged devices and/or systems than those shown in FIGS. 1A and 1B. Furthermore, two or more devices and/or systems shown in FIGS. 1A and 1B may be implemented within a single device and/or system, or a single device and/or system shown in FIGS. 1A and 1B may be implemented as multiple, distributed devices and/or systems. Additionally or alternatively, a set of devices and/or systems (e.g., one or more devices or systems) of environment 100 may perform one or more functions described as being performed by another set of devices and/or systems of environment 100.

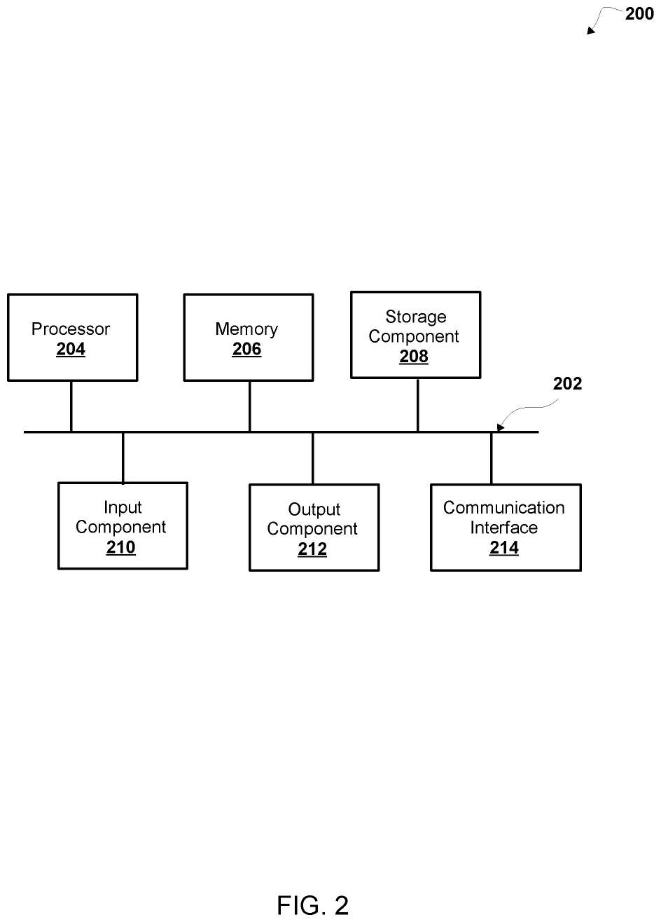

Referring now to FIG. 2, FIG. 2 is a diagram of example components of a device 200. Device 200 may correspond to one or more devices of transaction processing network 101, one or more devices of merchant system 102, one or more devices of payment gateway system 104, one or more devices of acquirer system 106, one or more devices of transaction service provider system 108, one or more devices of issuer system 110, and/or user device 112 (e.g., one or more devices of a system of user device 112, etc.). In some non-limiting embodiments or aspects, one or more devices of transaction processing network 101, one or more devices of merchant system 102, one or more devices of payment gateway system 104, one or more devices of acquirer system 106, one or more devices of transaction service provider system 108, one or more devices of issuer system 110, user device 112 (e.g., one or more devices of a system of user device 112, etc.), and/or one or more devices of communication network 114 may include at least one device 200 and/or at least one component of device 200. As shown in FIG. 2, device 200 may include a bus 202, a processor 204, memory 206, a storage component 208, an input component 210, an output component 212, and a communication interface 214.

Bus 202 may include a component that permits communication among the components of device 200. In some non-limiting embodiments or aspects, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

Memory 206 and/or storage component 208 may include data storage or one or more data structures (e.g., a database, etc.). Device 200 may be capable of receiving information from, storing information in, communicating information to, or searching information stored in the data storage or one or more data structures in memory 206 and/or storage component 208. For example, transaction service provider system 108 may include and/or access one or more internal and/or external databases that store transaction data associated with transactions processed and/or being processed in transaction processing network 101 (e.g., prior or historical transactions processed via transaction service provider system 108, etc.), account data, input data, output data, update data, sorted data, and/or the like.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

Referring now to FIG. 3, FIG. 3 is a flowchart of non-limiting embodiments or aspects of a process 300 for maintaining model state. In some non-limiting embodiments or aspects, one or more of the steps of process 300 may be performed (e.g., completely, partially, etc.) by transaction service provider system 108 (e.g., one or more devices of transaction service provider system 108, etc.). In some non-limiting embodiments or aspects, one or more of the steps of process 300 may be performed (e.g., completely, partially, etc.) by another device or a group of devices separate from or including transaction service provider system 108, such as merchant system 102 (e.g., one or more devices of merchant system 102), payment gateway system 104 (e.g., one or more devices of payment gateway system 104), acquirer system 106 (e.g., one or more devices of acquirer system 106), issuer system 110 (e.g., one or more devices of issuer system 110), and/or user device 112 (e.g., one or more devices of a system of user device 112).

As shown in FIG. 3, at step 302, process 300 includes receiving first input data. For example, transaction service provider system 108 (e.g., buffer/sorter system 154, etc.) may receive first input data. As an example, transaction service provider system 108 (e.g., buffer/sorter system 154, etc.) may receive first input data input, at a first time, to a first implementation of a machine learning model to generate first output data. In such an example, the first implementation of the machine learning model may be associated with a first model state at a time before the first time.

In some non-limiting embodiments or aspects, transaction service provider system 108 (e.g., first data center 152a, etc.) may process, at the first time, using the first implementation of the machine learning model, the first input data to generate the first output data without updating the first model state associated with the first implementation of the machine learning model. For example, and referring also to FIG. 4, FIG. 4 is a signal flow diagram of an implementation 400 of a non-limiting embodiment or aspect of a process for maintaining model state. Although FIG. 4 is described with respect to first data center 152a and second data center 152b receiving first input data and second input data, respectively, non-limiting embodiments or aspects of the present disclosure may include any number of data centers (e.g., n number of data centers as described with respect to FIG. 1B, etc.) and/or receive any number of events or inputs at any of the data centers (e.g., first input data may include a plurality of input data and/or be associated with a plurality of events or inputs, second input data may include a plurality of input data and/or be associated with a plurality of events or inputs, n^{th} input data, etc.). As shown in FIG. 4, at reference number 482, first data center 152a and buffer/sorter system 154 may receive (e.g., simultaneously receive, etc.) first input data at time T1 and/or a first model state of the first implementation of the machine learning model at first data center 152a at a time previous to the time T1 (e.g., previous to updating the model state based on the first input, etc.). For example, first data center 152a may receive the first input data at time T1 in response to receipt of the first input data by transaction service provider system 108 (e.g., in response to receipt and/or initiation of a transaction associated with the first input data, etc.), which may assign the input data to one of the data centers 152a, 152b, or 152n for processing according to one or more assignment protocols (e.g., data center availability, a predetermined data center assignment order, etc.). As an example, first data center 152a may provide the first input data at time T1 and the first model state of the first implementation of the machine learning model at first data center 152a at a time previous to time T1 to buffer/sorter system 154. In such an example, and referring again to FIG. 4, at reference number 484, first data center 152a may process, at time T1, using the first implementation of the machine learning model with the first model state at the time previous to time T1, the first input data to generate the first output data without updating the first model state associated with the first implementation of the machine learning model.

As shown in FIG. 3, at step 304, process 300 includes receiving second input data. For example, transaction service provider system 108 (e.g., buffer/sorter system 154, etc.) may receive second input data. As an example, transaction service provider system 108 (e.g., buffer/sorter system 154, etc.) may receive second input data input, at a second time different than the first time, to a second implementation of the machine learning model to generate second output data. In such an example, the second implementation of the machine learning model may be associated with a second model state at a time before the second time.

In some non-limiting embodiments or aspects, the first model state of the first implementation of the machine learning model at first data center 152a is the same as the second model state of the second implementation of the machine learning model at second data center 152b. For example, the first model state of the first implementation of the machine learning model at first data center 152a and the second model state of the second implementation of the machine learning model at second data center 152b may be determined based on the same input data and/or events. As an example, a consistent model state may be maintained across each implementation of the machine learning model (e.g., across each data center, etc.).

In some non-limiting embodiments or aspects, transaction service provider system 108 (e.g., second data center 152b, etc.) may process, at the second time, using the second implementation of the machine learning model, the second input data to generate the second output data without updating the second model state associated with the second implementation of the machine learning model. For example, and referring again to FIG. 4, at reference number 486, second data center 152b and buffer/sorter system 154 may receive (e.g., simultaneously receive, etc.) second input data at time T2 (e.g., after time T1) and/or a second model state of the second implementation of the machine learning model at second data center 152b at a time previous to the time T1 (e.g., previous to updating the model state based on the second input, etc.). For example, second data center 152b may receive the second input data at time T2 in response to receipt of the second input data by transaction service provider system 108 (e.g., in response to receipt and/or initiation of a transaction associated with the first input data, etc.), which may assign the input data to one of the data centers 152a, 152b, or 152n for processing according to one or more assignment protocols (e.g., data center availability, a predetermined data center assignment order, etc.). As an example, second data center 152b may provide the second input data at time T2 and the second model state of the second implementation of the machine learning model at second data center 152b at a time previous to time T2 to buffer/sorter system 154. In such an example, and referring again to FIG. 4, at reference number 488, second data center 152b may process, at time T2, using the second implementation of the machine learning model with the second model state at the time previous to time T2, the second input data to generate the second output data without updating the second model state associated with the second implementation of the machine learning model.

In some non-limiting embodiments or aspects, input data (e.g., first input data, second input data, etc.), may include transaction data. For example, the first input data may include first transaction data associated with a first transaction received and/or initiated at the first time (e.g., time T1), and the second input data may include second transaction data associated with a second transaction received and/or initiated at the second time (e.g., time T2). As an example, the second transaction may be received and/or initiated in transaction processing network 101 after the first transaction.

In some non-limiting embodiments or aspects, transaction data may include parameters associated with a transaction, such as an account identifier (e.g., a PAN, etc.), a transaction amount, a transaction date and time, a type of products and/or services associated with the transaction, a conversion rate of currency, a type of currency, a merchant type, a merchant name, a merchant location, a transaction approval (and/or decline) rate, and/or the like. For example, input features for the machine learning model may correspond to and/or be determined based on the parameters associated with a transaction. As an example, the machine learning model may be programmed and/or configured to provide an output or prediction for a fraud detection application, a stand-in processing application, an advertising application, a marketing application, and/or the like.

As shown in FIG. 3, at step 306, process 300 includes determining, based on first input data and second input data, update data. For example, transaction service provider system 108 (e.g., buffer/sorter system 154, etc.) may determine, based on first input data and second input data, update data. As an example, transaction service provider system 108 (e.g., buffer/sorter system 154, etc.) may determine, based on the first input data and the second input data, update data for the first model state of the first implementation of the machine learning model and the second model state of the second implementation of the machine learning model.

In some non-limiting embodiments or aspects, determining the update data includes sorting the first input data and the second input data based on the first time and the second time to generate sorted data, and the update data is determined based on the sorted data. For example, buffer/sorter system 154 may store the first input data and the second input data (e.g., store each outstanding event or input from each data center 152, etc.) and sort the first input data and the second input data based on the times T1 and T2 (e.g., based on the times at which the events occur or the input is received in transaction processing network 101, etc.). As an example, buffer/sorter system 154 may sort the first input data and the second input data in sequential order according to the times at which the first input data and the second input data are received (e.g., in transaction processing network 101, at transaction service provider system 108, at first data center 152a, at second data center 152b, etc.).

In some non-limiting embodiments or aspects, buffer/sorter system 154 determines the update data by determining, based on the sorted data, an updated model state for the first model state of the first implementation of the machine learning model and the second model state of the second implementation of the machine learning model.

As shown in FIG. 3, at step 308, process 300 includes providing update data. For example, transaction service provider system 108 (e.g., buffer/sorter system 154, etc.) may provide update data. As an example, transaction service provider system 108 (e.g., buffer/sorter system 154, etc.) may provide, at a third time subsequent to the first time and the second time, the update data for the first model state of the first implementation of the machine learning model and the second model state of the second implementation of the machine learning model.

As an example, and referring again to FIG. 4, at reference number 490, buffer/sorter system 154 may provide the update data to first data center 152a and second data center 152b for updating the first model state of the first implementation of the machine learning model and the second model state of the second implementation of the machine learning model. For example, buffer/sorter system 154 may provide the update data based on a designated time window (e.g., a previous one second time window, etc.). As an example, buffer/sorter system 154 may provide the update data based on each of the events or inputs received within the time window to first data center 152a and second data center 152b (e.g., in a batch format, etc.) for updating (e.g., at reference numbers 492 and 494 of FIG. 4) the machine learning model at each data center upon expiration of the time window. In such an example, the first model state and the second model state may be simultaneously updated at first data center 152a and second data center 152b, respectively. Accordingly, a consistent model state between first data center 152a and second data center 152b may be maintained.

In some non-limiting embodiments or aspects, buffer/sorter system 154 provides the update data by providing the updated model state for the first model state of the first implementation of the machine learning model and the second model state of the second implementation of the machine learning model. For example, buffer/sorter system 154 may calculate the updated model state for each of the data centers and provide the updated model state to each of the data centers. Accordingly, the updated model state may be calculated only once by buffer/sorter system 154 (e.g., rather than individually at each data center, etc.), which may save memory and processing resources at the individual data centers.

In some non-limiting embodiments or aspects, buffer/sorter system 154 may provide the update data by providing, to first data center 152a and second data center 152b, the sorted data. For example, and referring again to FIG. 4, at reference number 492, first data center 152a may determine, based on the sorted data, a first updated model state for the first model state of the first implementation of the machine learning model and update the first model state of the first implementation of the machine learning model based on the first updated model state. As an example, and still referring to FIG. 4, at reference number 494, second data center 152b may determine, based on the sorted data, a second updated model state for the second model state of the second implementation of the machine learning model and update the second model state of the second implementation of the machine learning model based on the second updated model state. In such an example, first data center 152a and second data center 152b may simultaneously update the first model state and the second model state, respectively. Accordingly, a consistent model state between first data center 152a and second data center 152b may be maintained.

Although embodiments or aspects have been described in detail for the purpose of illustration and description, it is to be understood that such detail is solely for that purpose and that embodiments or aspects are not limited to the disclosed embodiments or aspects, but, on the contrary, are intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method comprising:
receiving, with at least one processor, first input data input, at a first time, to a first implementation of a machine learning model to generate first output data, wherein the first implementation of the machine learning model is associated with a first model state at a time before the first time;
receiving, with at least one processor, second input data input, at a second time different than the first time, to a second implementation of the machine learning model to generate second output data, wherein the second implementation of the machine learning model is associated with a second model state at a time before the second time;
determining, with at least one processor, based on the first input data and the second input data, update data for the first model state of the first implementation of the machine learning model and the second model state of the second implementation of the machine learning model; and
providing, with at least one processor, at a third time subsequent to the first time and the second time, the update data for the first model state of the first implementation of the machine learning model and the second model state of the second implementation of the machine learning model.

2. The computer-implemented method of claim 1, wherein determining the update data includes sorting the first input data and the second input data based on the first time and the second time to generate sorted data, and wherein the update data is determined based on the sorted data.

3. The computer-implemented method of claim 2, wherein determining the update data further includes determining, based on the sorted data, an updated model state for the first model state of the first implementation of the machine learning model and the second model state of the second implementation of the machine learning model, and wherein providing the update data further includes providing the updated model state for the first model state of the first implementation of the machine learning model and the second model state of the second implementation of the machine learning model.

4. The computer-implemented method of claim 2, wherein providing the update data further includes:
providing the sorted data for the first model state of the first implementation of the machine learning model and the second model state of the second implementation of the machine learning model, and wherein providing the update data further includes:
determining, based on the sorted data, a first updated model state for the first model state of the first implementation of the machine learning model;
updating the first model state of the first implementation of the machine learning model based on the first updated model state;
determining a second updated model state for the second model state of the second implementation of the machine learning model; and
updating the second model state of the second implementation of the machine learning model based on the second updated model state.

5. The computer-implemented method of claim 1, further comprising:
processing, at the first time, with at least one processor using the first implementation of the machine learning model, the first input data to generate the first output data without updating the first model state associated with the first implementation of the machine learning model.

6. The computer-implemented method of claim 5, further comprising:
processing, at the second time, with at least one processor using the second implementation of the machine learning model, the second input data to generate the second output data without updating the second model state associated with the second implementation of the machine learning model.

7. The computer-implemented method of claim 1, wherein the first input data includes first transaction data associated with a first transaction initiated at the first time, and wherein the second input data includes second transaction data associated with a second transaction initiated at the second time.

8. A computing system comprising:
one or more processors programmed and/or configured to:
receive first input data input, at a first time, to a first implementation of a machine learning model to generate first output data, wherein the first implementation of the machine learning model is associated with a first model state at a time before the first time;
receive second input data input, at a second time different than the first time, to a second implementation of the machine learning model to generate second output data, wherein the second implementation of the machine learning model is associated with a second model state at a time before the second time;
determine, based on the first input data and the second input data, update data for the first model state of the first implementation of the machine learning model and the second model state of the second implementation of the machine learning model; and
provide at a third time subsequent to the first time and the second time, the update data for the first model state of the first implementation of the machine learning model and the second model state of the second implementation of the machine learning model.

9. The computing system of claim 8, wherein the one or more processors determine the update data by sorting the first input data and the second input data based on the first time and the second time to generate sorted data, wherein the update data is determined based on the sorted data.

10. The computing system of claim 9, wherein the one or more processors determine the update data by determining, based on the sorted data, an updated model state for the first model state of the first implementation of the machine learning model and the second model state of the second implementation of the machine learning model, and wherein the one or more processors provide the update data by providing the updated model state for the first model state of the first implementation of the machine learning model and the second model state of the second implementation of the machine learning model.

11. The computing system of claim 9, further comprising:
a first data center programmed and/or configured to provide the first implementation of the machine learning model; and
a second data center programmed and/or configured to provide the second implementation of the machine learning model,
wherein the one or more processors provide the update data by providing, to the first data center and the second data center, the sorted data,
wherein the first data center is further programmed and/or configured to:
determine, based on the sorted data, a first updated model state for the first model state of the first implementation of the machine learning model; and
update the first model state of the first implementation of the machine learning model based on the first updated model state, and
wherein the second data center is further programmed and/or configured to:
determine, based on the sorted data, a second updated model state for the second model state of the second implementation of the machine learning model; and
update the second model state of the second implementation of the machine learning model based on the second updated model state.

12. The computing system of claim 8, further comprising:
a first data center programmed and/or configured to:
provide the first implementation of the machine learning model; and
process, at the first time, using the first implementation of the machine learning model, the first input data to generate the first output data without updating the first model state associated with the first implementation of the machine learning model.

13. The computing system of claim 12, further comprising:
a second data center programmed and/or configured to:
provide the second implementation of the machine learning model; and
process, at the second time, using the second implementation of the machine learning model, the second input data to generate the second output data without updating the second model state associated with the second implementation of the machine learning model.

14. The computing system of claim 8, wherein the first input data includes first transaction data associated with a first transaction initiated at the first time, and wherein the second input data includes second transaction data associated with a second transaction initiated at the second time.

15. A computer program product comprising at least one non-transitory computer-readable medium including program instructions that, when executed by at least one processor, cause the at least one processor to:
receive first input data input, at a first time, to a first implementation of a machine learning model to generate first output data, wherein the first implementation of the machine learning model is associated with a first model state at a time before the first time;
receive second input data input, at a second time different than the first time, to a second implementation of the machine learning model to generate second output data, wherein the second implementation of the machine learning model is associated with a second model state at a time before the second time;
determine based on the first input data and the second input data, update data for the first model state of the first implementation of the machine learning model and the second model state of the second implementation of the machine learning model; and
provide at a third time subsequent to the first time and the second time, the update data for the first model state of the first implementation of the machine learning model and the second model state of the second implementation of the machine learning model.

16. The computer program product of claim 15, wherein the instructions cause the at least one processor to determine the update data by sorting the first input data and the second input data based on the first time and the second time to generate sorted data, and wherein the update data is determined based on the sorted data.

17. The computer program product of claim 16, wherein the instructions cause the at least one processor to determine the update data by determining, based on the sorted data, an updated model state for the first model state of the first implementation of the machine learning model and the second model state of the second implementation of the machine learning model, and wherein the instructions cause the at least one processor to provide the update data by providing the updated model state for the first model state of the first implementation of the machine learning model and the second model state of the second implementation of the machine learning model.

18. The computer program product of claim 16, wherein the instructions cause the at least one processor to provide the update data by:
providing the sorted data as the update data for the first model state of the first implementation of the machine learning model and the second model state of the second implementation of the machine learning model;
determining, based on the sorted data, a first updated model state for the first model state of the first implementation of the machine learning model;
updating the first model state of the first implementation of the machine learning model based on the first updated model state;
determining a second updated model state for the second model state of the second implementation of the machine learning model; and
updating the second model state of the second implementation of the machine learning model based on the second updated model state.

19. The computer program product of claim 15, wherein the instructions further cause the at least one processor to:
process, at the first time, using the first implementation of the machine learning model, the first input data to generate the first output data without updating the first model state associated with the first implementation of the machine learning model; and
process, at the second time, using the second implementation of the machine learning model, the second input data to generate the second output data without updating the second model state associated with the second implementation of the machine learning model.

20. The computer program product of claim 15, wherein the first input data includes first transaction data associated with a first transaction initiated at the first time, and wherein the second input data includes second transaction data associated with a second transaction initiated at the second time.
